(19) United States
(12) Patent Application Publication
(10) Pub. No.: US 2010/0025986 A1
(43) Pub. Date: Feb. 4, 2010

(54) HOSE FITTING

(76) Inventor: Roderick Seton-Anderson, Bradford (GB)

Correspondence Address: HOWARD & HOWARD ATTORNEYS PLLC, 450 West Fourth Street, Royal Oak, MI, 48067, US

(21) Appl. No.: 12/442,003

(22) PCT Filed: Sep. 28, 2007
(86) PCT No.: PCT/GB2007/003685

§ 371 Date: Sep. 4, 2009

(30) Foreign Application Priority Data
Oct. 7, 2006 (GB) 0619884.0

(51) Int. Cl. F16L 33/22; F16L 33/207

(52) U.S. Cl. 285/257

(57) ABSTRACT

A hose end fitting in which a connection body (300) is secured to a hose end (401) by an inner sleeve (200) and an outer collar (100). A radius of an outer surface (201) of the inner sleeve (200) is greater than a radius of an inner surface (102) of the outer collar (100) such that when the outer collar (100) is forced over the inner sleeve (200), the inner sleeve is radially compressed onto the hose end. The outer collar (100) and inner sleeve (200) are locked in position by the radial expansion force of the compressed hose (401) and the inner sleeve (200).

### CROSS REFERENCE TO RELATED APPLICATION

The subject patent application claims priority to and all the benefits of International Application No. PCT/GB20071003685, which was filed on Sep. 28, 2007 with the World Intellectual Property Organization.

### BACKGROUND OF THE INVENTION

1. Field of the Invention

The present invention relates to a hose fitting and in particular, although not exclusively, to a reusable hose fitting.

2. Description of the Prior Art

Rubber and plastic hoses find extensive use in a variety of specific industrial and domestic applications. In the majority of these applications a connection body is secured to at least one end of the hose so as to provide a means of connection to other hoses or devices.

Generally, it is a requirement that these connection bodies, alternatively termed end fittings, are attached to the hose in such a way that fluid passing through the hose, typically under pressure or a partial vacuum, does not leak at the interface between the hose and end fitting. In extreme implementations, the end fitting may be required to maintain integrity up to the burst pressure of the hose and to withstand the effects of vibration and accidental damage during use.

U.S. Pat. No. 5,678,867 discloses a hose fitting assembly for attaching an end portion of a hose to an end fitting in which the hose is sandwiched between an inner sleeve extending from the end fitting and an outer collar which is locked in position by clamping members. Compression means operate to radially compress the hose between the outer collar and the inner sleeve. Separate lock means are provided to prevent longitudinal separation of the end fitting from the hose as the fluid pressure changes.

EP 0811801 discloses an end fitting in which the fluid tight seal is provided by a plastic pressure ring sandwiched between a pipe support sleeve and a clamping nut. The clamping nut is provided with a conical internal surface which cooperates with a corresponding conical surface of the pipe support sleeve to clamp the pressure ring and compress the pipe. Annularly spaced apart open end cuts are formed in the pressure ring to allow circumferential and radial deformation of the pressure ring in response to clamping of the locking nut to enable the fitting to be used for connecting pipes of different diameters.

US 2003/0001385 discloses a reusable hose coupling having an outer locking nut that is secured over an intermediate ferrule adapted for positioning against the outer surface of the hose end. A tail portion of the connection body positioned against the inner surface of the hose provides the cooperating and opposing face of the sandwich. The fitting is secured to the hose by the locking nut which acts to compress the ferrule against the hose end.

U.S. Pat. No. 5,558,375 describes a reusable hose fitting having screw threads provided on its exterior surface for cooperating with the screw threads provided on an exterior surface of a locking nut. The hose end is sandwiched between an intermediate annular ferrule and a tail portion of the hose fitting positioned within the hose. The locking nut and intermediate ferrule comprise cooperating tapered regions such that as the locking nut is screwed over the end fitting, the tapered faces are brought into contact so as to provide compression of the ferrule and the corresponding region of the hose end.

US 2002/0000721 teaches of a sleeve-type pipe joint having an outer collar that is secured over an inner sleeve which in turn is sandwiched between the outer collar and an outer surface of the hose end. A tail portion of the hose end fitting is inserted within the hose and sits against its inner surface whereby the hose end is sandwiched between the inner sleeve and the tail portion of the hose fitting. The fluid seal is provided by cooperating tapered regions of the outer collar and inner sleeve which when brought into contact serve to compress the hose end. According to different embodiments, either the outer collar or inner sleeve are locked in position at the end fitting by suitable locking means in the form of a projection configured to sit within a corresponding groove.

There are a number of disadvantages associated with conventional reusable end fittings. Hose end connections where an outer collar provides a compression force to an inner sleeve must be secured in position at the fitting to maintain contact between the fitting and hose. This is achieved conventionally by locking means in the form of cooperating screw threads, tong and groove arrangements and other types of clamping means serving to secure the outer collar to the end fitting alternatively termed a spigot. This type of locking means is essential where cooperating tapered faces or regions are provided between the outer collar and inner sleeve so as to achieve the required compression of the hose. Without the mechanical locking means the opposed tapered regions would be forced apart destroying the fluid tight seal between the hose and end fitting.

The implementation of mechanical locking means necessitates additional machining and processing of both the end fitting and the outer collar which is costly both in terms of processing time and materials. Utilisation of tapered surfaces also restricts the length of the inner sleeve as the thickness of the sleeve is reduced along its length due to the incorporation of the taper. What is required therefore is an end fitting that addresses the above identified problems.

### SUMMARY OF THE INVENTION AND ADVANTAGES

The present invention provides a convenient and efficient means for releasably securing an end fitting to a hose enabling the hose to be connected to other hoses and devices etc. The hose is secured to the end fitting using an outer collar and an inner compressible sleeve which may be compressed against the outer surface of the hose by the outer collar. Advantageously, the present invention does not necessitate additional locking means so as to adequately secure the end fitting to the hose. In contrast, the locking action is provided by the frictional contact between the inner surface of the outer collar and the outer surface of the inner sleeve.

The present invention is advantageous over conventional concentric locking collars that comprise tapering in the region of compression for two reasons. Firstly, by utilising an outer collar and inner sleeve being devoid of a taper in the region of compression, the frictional locking force between the two mating surfaces obviates the need for an additional mechanical locking means which is otherwise required with conventional tapered collars and sleeves. The inner surface of the outer collar and inner and outer surfaces of the inner sleeve of the present invention are aligned substantially parallel to the longitudinal axis of the outer collar, inner sleeve and connection body such that the locking force between the inner sleeve and outer collar in the axial direction is substantially uniform. Secondly, the length of the outer collar and the inner is not limited as with conventional tapered systems in which the length of the collar and sleeve is limited by their relative increasing and decreasing wall thicknesses. The present invention in turn provides increased design flexibility and the possibility of increasing the strength of seal by increasing the length of collar and sleeve as required.

Through the cooperation between the outer collar and inner sleeve, the present invention is configurable to maintain a fluid tight seal between the end fitting and the hose up to the burst pressure of the hose. Additionally, the present invention is designed to allow easy land convenient release of the locking action provided by the outer collar and inner sleeve to enable extraction of the connection body from the hose for reuse. The outer collar is also designed to be reusable.

According to a first aspect of the present invention there is provided a hose fitting comprising: an inner sleeve having an inner and outer surface, said inner surface configured for positioning over an outer surface of a compressible hose capable of receiving a connection body internally within said hose, said inner sleeve capable of radial compression over a region of its length; and an outer collar having an inner surface configured for positioning over said outer surface of said inner sleeve wherein prior to contact with said inner sleeve a radius of a region of said inner surface of said outer collar is less than a radius of a region of said outer surface of said inner sleeve, wherein said outer collar is configured to radially compress said inner sleeve and said hose against said connection body such that in the region of compression said inner surface of said outer collar and said inner and outer surfaces of said inner sleeve are aligned substantially parallel with the longitudinal axis of inner sleeve and said outer collar; wherein said outer collar may be held in position over said inner sleeve exclusively by the longitudinally extending frictional contact between said inner surface of said outer collar and said outer surface of inner sleeve in response to the radial expansion force of said compressed hose and said inner sleeve positioned between said outer collar and said connection body.

The present fitting is particularly suitable to releasably attach a connection body having a tubular tail portion to a tubular hose. The tubular tail portion, having an outer surface which is aligned substantially axially parallel to the longitudinal axis of the connection body, provides a rigid structure against which the inner sleeve and hose end may be compressed. The tubular portion of the connection body may comprise a profiled or non-profiled outer surface according to known connection bodies found in the art.

Preferably, the inner sleeve comprises a tapered leading edge extending between its inner and outer surface. Similarly, the outer collar may also comprise a tapered leading edge configured to mate with the tapered leading edge of the inner sleeve as the outer collar is slid over the inner sleeve. These leading edges only serve the purpose of initially guiding the inner sleeve into a correct internal engagement with the outer collar, they do not perform any other compressive function following correct concentric engagement.

Further, the inner surface of the inner sleeve may comprise an annular groove configured to mate with an annular shoulder extending from the connection body, the cooperation between the groove and shoulder being configured to inhibit longitudinal displacement of the inner sleeve relative to the connection body.

The outer collar may comprise at least one or a plurality of recessed grooves or indented portions provided on its internal surface. Preferably, two annular grooves are formed at the internal surface of the outer collar, each groove being axially spaced from one another. The indented regions serve to reduce friction between the outer collar and the inner sleeve as the mating surfaces are brought together.

According to a further implementation, the inner sleeve comprises a shoulder extending from its inner surface configured to mate with a shoulder extending from the connection body. The shoulders are mated to abut one another as the inner sleeve is compressed radially through frictional contact with the outer collar. The interlocking shoulders of the connection body and inner sleeve serve to inhibit longitudinal displacement of the inner sleeve relative to the connection body.

Further embodiments to prevent longitudinal slip of the inner sleeve include conventional tongue and groove type arrangements.

Preferably, the inner sleeve and outer collar comprise a substantially cylindrical geometry enabling them to be positioned over and about an elongate cylindrical hose.

The inner sleeve comprises substantially axially parallel inner and outer surfaces extending over a region of its length. Preferably, the outer collar comprises substantially axially parallel inner and outer surfaces extending over a region of its length.

Importantly, and to ensure a satisfactory locking force is achieved between the inner sleeve and outer collar, in the region of compression, the inner surface of the outer collar and the inner and outer surfaces of the inner sleeve are aligned substantially parallel with the longitudinal axis of the inner sleeve, outer collar and tubular portion of the connection body inserted within the tubular hose. That is, in the region of compression, physical contact between the outer collar, inner sleeve, hose end and the tubular tail region of the connection body is made via surfaces aligned substantially parallel with the longitudinal axis of the collar, sleeve, connection body and hose. Particularly, the longitudinal wall thicknesses of the inner sleeve over the region of compression is substantially uniform.

Preferably, the outer collar comprises an annular groove recessed into its outer surface. This groove enables the outer collar to be held in position between opposing jaws of a device so that the outer collar may be axially restrained during assembly of the fitting at the hose end. Alternatively, the outer collar comprises diametrically opposed substantially flat regions recessed into its outer surface.

The inner sleeve is configured for deformation and may comprises a deformable material including in particular a metal, a steel, stainless steel, a plastic, or rubber. Further, the outer collar may be metal and preferably steel or stainless steel. The inner sleeve is configured for elastic deformation such that when compressed by the outer collar the inner sleeve provides a return expansion force which in addition to the expansion force provided by the compressed hose, serves to lock the outer collar in position at the hose end. The inner sleeve is configured to transfer the return expansion force of the compressed hose to the inner surface of the outer collar.

Preferably, the inner sleeve comprises at least one slot and in particular a plurality of slots extending longitudinally over a region of its length to be compressed. The at least one slot is preferably open at one end of the inner sleeve so as to allow radial compression of the sleeve as the slot widths are reduced. In particular, the plurality of slots may be substantially parallel aligned.

Optionally, to decrease the frictional contact between the outer collar and the inner sleeve so as to ease the assembly operation but not compromise integrity of the resulting joint, the inner surface of the outer collar may have internal radial grooves cut into it thereby reducing the surface area in contact with the inner sleeve.

Optionally, to increase the frictional contact between the outer collar and the inner sleeve, the inner surface of the outer collar and outer surface of the inner sleeve may be roughened by machining. The surface roughening may comprise machined, radial or spiral grooves cut into the respective outer and inner surfaces. Surface roughening may also be provided at the inner surface of the inner sleeve configured for positioning in contact with the outer surface of the hose. Optionally, barbs may be provided on the inner surface of the inner sleeve configured to bite into the outer region of the hose to inhibit axial displacement.

According to a second aspect of the present invention there is provided: a method of releasably securing a connection body to a hose, said method comprising inserting a connection body within an end region of a compressible hose; positioning an inner sleeve over said hose at the region of said connection body; sliding an outer collar over an outer surface of said inner sleeve wherein prior to contact with said inner sleeve a radius of a region of an inner surface of said outer collar is less than a radius of a region of said outer surface of said inner sleeve; and radially compressing said inner sleeve and said hose on to said connection body as said outer collar is slid over said inner sleeve wherein said outer collar is held in position over said inner sleeve exclusively by the longitudinally extending frictional contact between said inner surface of said outer collar and said outer surface of said inner sleeve in response to the radial expansion of the compressed hose and said inner sleeve positioned between said outer collar and said connection body such that in the region of compression said inner surface of said outer collar and said inner and outer surfaces of said inner sleeve are aligned substantially parallel with the longitudinal axis of inner sleeve and said outer collar.

### BRIEF DESCRIPTION OF THE DRAWINGS

Specific implementations of the invention will now be described by way of example only with reference to the accompanying drawings.

FIG. 1 is a cross sectional side elevation view of an outer collar.

FIG. 2 is a cross sectional side elevation view of an inner sleeve.

FIG. 3 is a cross sectional side elevation view of a connection body.

FIG. 4a is a cross sectional side elevation view of the outer collar, inner sleeve and connection body of FIGS. 1 to 3 partially secured in position about an end region of a hose during assembly.

FIG. 4b is a cross sectional side elevation view of the outer collar, inner sleeve and connection body of FIGS. 1 to 3 fully secured in position about an end region of a hose following assembly.

FIG. 4c is a cross sectional side elevation view of the outer collar, inner sleeve and connection body includes a further specific implementation.

FIG. 5 is a perspective view of a device usable to assemble and disconnect the connection body to a hose using the outer collar and inner sleeve of FIGS. 1 and 2.

### DETAILED DESCRIPTION OF THE INVENTION

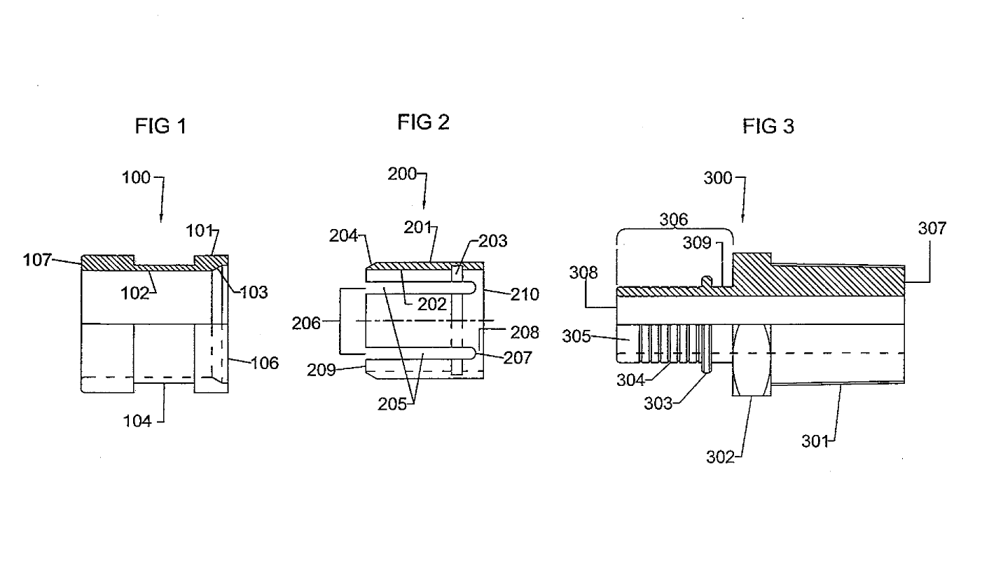

Referring to FIG. 1, a collar 100 comprises a substantially cylindrical like configuration having an outer surface 101 and an inner surface 102. Towards a second end 106 of collar 100 a tapered region 103 is provided on inner surface 102 such that the thickness of the collar wall decreases in the region of the taper 103 from the first end 107 to second end 106. Accordingly, the radius of the inner surface at the second end 106 is greater than the radius of the inner surface at the first end 107.

An annular groove 104 is recessed into outer surface 101 and positioned substantially midway between first and second ends 107, 106.

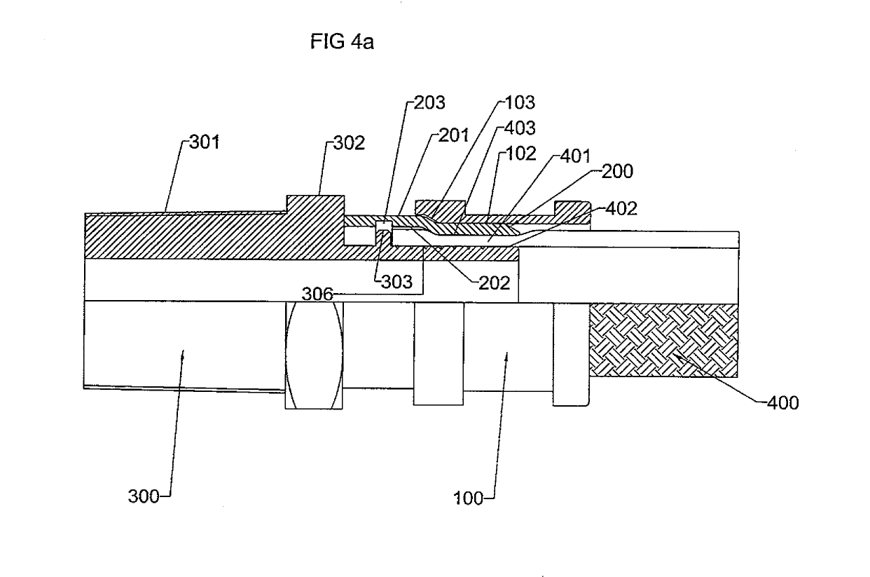

Referring to FIG. 2, an inner sleeve 200 comprises a substantial cylindrical configuration having an outer surface 201 and an inner surface 202. A leading edge 204 at a first end 209 comprises a taper extending between inner surface 202 and outer surface 201. Taper 204 corresponds in gradient to taper 103 provided at inner surface 102 of outer collar 100. The diameter of entrance 106 is equal to or slightly larger than the diameter of end 209 of inner sleeve 200 to allow insertion of sleeve 200 within collar 100 and engagement between tapered regions 103, 204.

A plurality of elongate slots 205 extend longitudinally through the sleeve wall from the first end 209 towards a second end 210. Each slot 205 comprises an open end 206 provided at first end 209 whilst a second end 207 terminates at a region along the length of sleeve 200. Accordingly, a region 208 of sleeve 200 is devoid of slots or holes and maintains an annular ring configuration.

An annular groove 203 is indented on inner surface 202 and is displaced in one half of sleeve 200 towards second end 210.

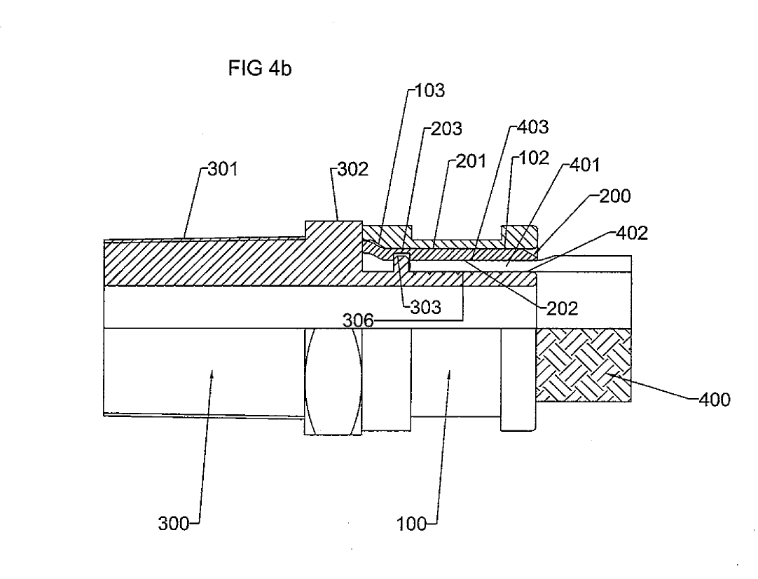

Referring to FIG. 3, a connection body 300, alternatively termed a spigot, comprises a conical end region 301 having screw threads on its external surface. The larger diameter end of conical end portion 301 is bordered by a hexagonal first shoulder 302 of greater cross sectional width than cone 301. An elongate tail 306 extends from the first shoulder 302 having a diameter less than first shoulder 302 and cone 301. Tail 306 comprises a second shoulder 303 having a larger diameter than tail 306.

Connection body 300 comprises a first end 307 corresponding to the smaller diameter end of cone 301 and a second end 308 corresponding to an end region of elongate tail 306. A plurality of grooves 304 are formed on the outer surface of tail 306 and extend over a region between second shoulder 303 and second end 308. Connection body 300 comprises a through bore 305 defining an inner tubular surface extending between first and second ends 307, 308. The first and second shoulders 302, 303 are separated by annular region 309.

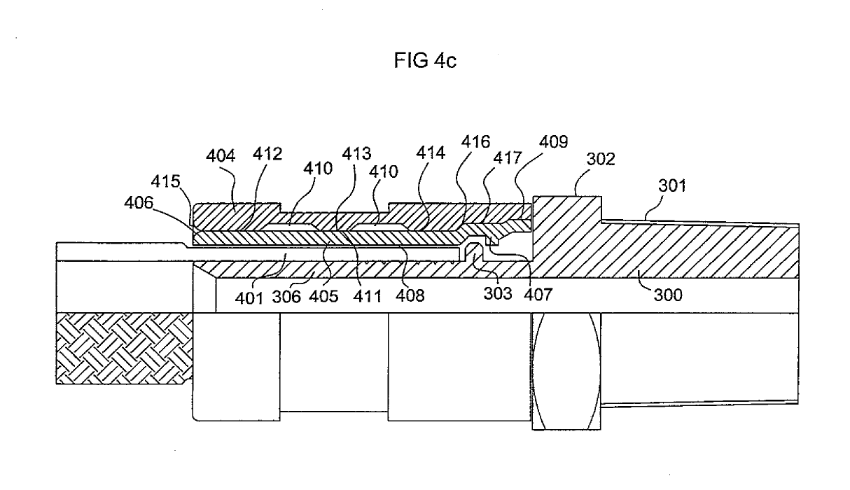

FIGS. 4a and 4b illustrate the end fitting partially and fully assembled at the hose end, respectively. To assemble the end fitting and releasably secure the connection body 300 to hose end 400, outer collar 100 and inner sleeve 200 are positioned over hose 400. Tail 306 of connection body 300 is inserted within the open end of hose 401 until the end face of hose 401 abuts shoulder 303. Accordingly an outer surface of tail 306 is positioned in contact with an inner surface 402 of hose end 401. Inner sleeve 200 is then moved into position over the outer surface 403 of hose end 401 so as to abut first shoulder 302. Outer collar 100 is then moved into position over inner sleeve 200, resulting in the radial compression of inner sleeve 200 onto the outer surface of the hose end 401. Sleeve 200 is located in position as second shoulder 303 is mated within annular groove 203 so as to inhibit longitudinal displacement of sleeve 200 relative to connection body 300. Inner surface 202 of sleeve 200 is thereby positioned in contact with outer surface 403 of hose end 401.

FIG. 4c illustrates a further embodiment of the end fitting comprising outer collar 404 and inner sleeve 405. Sleeve 405 comprises the elongated slots 205 (not shown) and a lead-in taper 406 corresponding to taper 204 of FIG. 2. In contrast to the radial groove 203 extending internally within sleeve 200 of the embodiment of FIG. 2, sleeve 405 comprises a radial inwardly projecting shoulder 407 extending from inner surface 408 and towards one end 409 of sleeve 405.

Outer collar 404 corresponding to outer collar 100 of the embodiment of FIG. 1 additionally comprises two annular grooves 410 extending from its inner surface 412, 413, 414. Grooves 410 are spaced apart in the longitudinal direction of collar 404 so as to define a first annular compression surface 412 extending from the tapered lead-in end 405; a second annular compression surface 413 extending between recessed grooves 410 and a third annular compression surface 414 is positioned between groove 410 and the second end of collar 404. The thickness of outer collar 404 decreases at a tapered region 416 bordering compression surface 414 to provide a larger diameter internal locking surface 417.

In operation, annular grooves 410 serve to relieve friction between inner surface 412, 413, 414 of collar 404 and outer surface 411 of sleeve 405 as collar 404 is slid over sleeve 405 positioned over and about compressible hose 401 and tail 306 of connection body 300.

As collar 404 is slid completely over the outer surface of sleeve 405, compression surface 417 compresses inner sleeve 405 at the region of internal shoulder 407 so as to radially compress shoulder 407 in to a locking position immediately behind shoulder 303 extending from tail 306 of connection body 300. Accordingly, compressible hose 401 is secured in position at connection body 300 by a combination of the expansion force resulting from compression of sleeve 405 and hose end 401 and the abutted shoulders 303, 407. The frictional contact between sleeve 405 and collar 404 is provided predominantly in the region of the locking surfaces 412, 413, 414 spaced apart in the longitudinal direction by annular grooves 410.

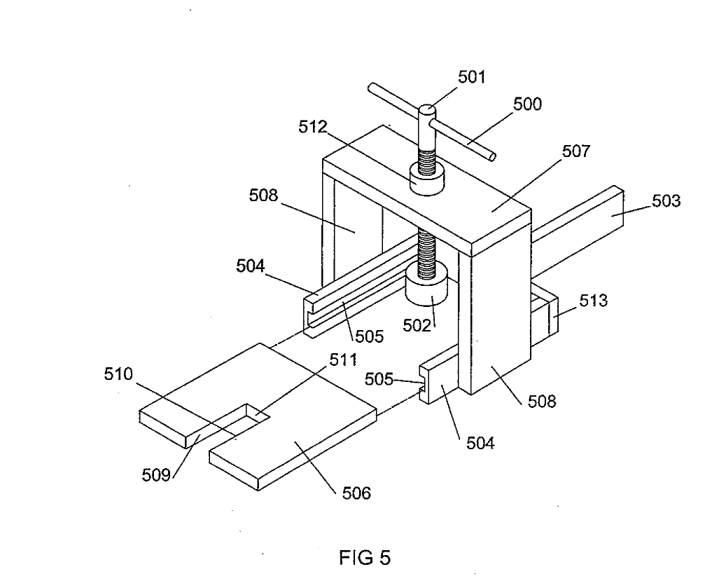

FIG. 5 illustrates one example of a device for removably securing outer collar 100 in position over and about inner sleeve 200. The end fitting assembly device of FIG. 5 comprises a handle 500 secured to a central spindle 501 comprising external screw threads. Spindle 501 extends through a hollow boss 512 comprising corresponding screw threads formed on its internal surface. Spindle 501 may be displaced back and forth relative to boss 512 by rotation of handle 500 involving cooperation between the opposed screw threads.

The boss 512 is mounted on a bridge 507. A pair of legs 508 extend from either end of bridge 507 and terminate at two opposing arms 504 of a Y-shaped member 513 aligned substantially perpendicular to legs 508. A single arm 503 forms a single spoke of the Y member and is used to allow the device to be clamped by a vice or similar apparatus.

Each of the opposed arms 504 comprise a groove 505 extending along its length. Each groove 505 is configured to receive the end region of an elongate plate 506 which may be removably slotted into position between opposing arms 504 via grooves 505. Plate 506 comprises a substantially rectangular cut-out section 511 positioned substantially midway along its length.

An engagement boss 502 is connected at one end of spindle 501 and is configured to mate and releasably engage with connection body 300. Engagement boss 502 is configured to swivel freely with respect to spindle 501 by way of a conventional configuration as will be appreciated by those skilled in the art such that axial compression may be applied to connection body 300 without connection body 300 being rotated. The gap between surfaces 509, 510 of cut out section 511 is slightly larger than the diameter of groove 104, but less than the diameter of outer surface 101 of outer collar 100 so as to prevent axial displacement of collar 100 during assembly.

To assemble the end fitting, outer collar 100 is inserted within cut-out 511 such that groove 104 is positioned loosely between opposing faces 509, 510 of plate 506 which is held in position within grooves 505. As outer collar 100 is held in substantially axially fixed position, connection body 300 and inner sleeve 200 are displaced axially by the clockwise rotation of handle 500 and spindle 501 so as to force outer collar 100 over the outer surface of inner sleeve 200. As the radius of the outer surface 201 of the inner sleeve 200 is greater than the radius of the inner surface 102 of the outer collar 100, radial compression of the inner sleeve 200 is provided as inner surface 102 of outer collar 100 is forced over outer surface 201 of inner sleeve 200. Second end 106 of outer collar 100 passes over outer surface 201 of inner sleeve 200 towards end 210 to abut shoulder 302 as illustrated in FIGS. 4a and 4b.

The tubular inner sleeve 200 is designed by the use of slots or like means in such a way that it can be collapsed to a smaller diameter with the application of a radially applied force that is much smaller than the force required to collapse a conventional unslotted tube, cold-forged by crimping or swaging. The end fitting may therefore be assembled using a hand operated tool of the type of FIG. 5 to force the outer collar over the inner sleeve obviating the need for powered hydraulic apparatus.

Once assembled as illustrated in FIG. 4b, outer collar 100 is axially locked in position over and about inner sleeve 200 by the friction resulting from the action of the elastic memory of the compressed inner sleeve 200 and hose end 401. Accordingly, the locking force is provided by a combination of the expansion force resulting from compression of inner sleeve 200 and hose end 401 on to connection body 300. The appreciable return force exhibited by inner sleeve 200 is due in part to the annular ring 208 extending between sleeve end 210 and end 207 of slots 205. The assembly is therefore held in a locked position by the frictional contact force between outer surface 201 of inner sleeve 200 and inner surface 102 of outer collar 100. The frictional contact between inner sleeve 200 and outer collar 100 extends substantially over the entire compressed length of inner sleeve 200.

Once assembled, the end fitting may be disassembled by a reversal of the assembly process involving forcing outer collar 100 from outer surface 201 of inner sleeve 200. The disconnection may be achieved using the hand tool of FIG. 5 in which a suitable connection device (not shown) is used to connect boss 502 and connection body 300 whereby counterclockwise rotation of handle 500 forces separation of outer collar 100 from inner sleeve 200. After separation, collar 100 and connection body 300 may then be recovered and reused. Optionally, and depending upon the choice of material from which is it made, inner sleeve 200 may also be configured for reuse following initial assembly.

Unlike conventional reusable hose end fittings, the locking action is such that outer collar 100 may be removed only by the use of either extreme force or a specifically designed hand tool. This renders the attachment both secure and tamperproof. Conventional crimped and swaged non-reusable end fittings can be removed only by sawing or cutting through the securing collar which typically results in damage to the connection body which must then be discarded preventing reuse. The present end fitting may be disassembled without damage to the connection body allowing reuse.

To achieve the required degree of collapse of inner sleeve 200 without the use of excessive force, the width of slots 205 should be wide enough so that when inner sleeve 200 is fully collapsed to compress the hose 401 down to the required diameter, the opposite longitudinal edge faces of the slots should be pressed towards each other so that they either leave a gap, or are just touching, but are not compressed hard against each other.

This design of the inner sleeve 200 provides that it is capable of being collapsed to the required diameter without any cold forging, so that the wall thickness and length of sleeve 200 remain substantially the same. The high forces required for cold forging are therefore avoided.

The invention has been described in an illustrative manner, and it is to be understood that the terminology which has been used is intended to be in the nature of words of description rather than of limitation. As is now apparent to those skilled in the art, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

1. A hose fitting comprising:
an inner sleeve (200, 405) having an inner (202, 408) and outer (201, 411) surface, said inner surface (202, 408) configured for positioning over an outer surface (403) of a compressable hose (401) capable of receiving a connection body (300) internally within said hose (401), said inner sleeve (200, 405) capable of radial compression over a region of its length; and
an outer collar (100, 404) having an inner surface (102, 412, 413, 414) configured for positioning over said outer surface (201, 411) of said inner sleeve (200, 405) wherein prior to contact with said inner sleeve (200, 405) a radius of a region of said inner surface (102, 412, 413, 414) of said outer collar (100, 404) is less than a radius of a region of said outer surface (201, 411) of said inner sleeve (200, 405), wherein said outer collar (100, 404) is configured to radially compress said inner sleeve (200, 405) and said hose (401) against said connection body (300) such that in the region of compression said inner surface (102, 412, 413, 414) of said outer collar (100, 404) and said inner (202, 408) and outer (201, 411) surfaces of said inner sleeve (200, 405) are aligned substantially parallel with the longitudinal axis of said inner sleeve (200, 405) and said outer collar (100, 404);
wherein said outer collar (100, 404) may be held in position over said inner sleeve (200, 405) exclusively by the longitudinally extending frictional contact between said inner surface (102, 412, 413, 414) of said outer collar (100, 404) and said outer surface (201, 411) of said inner sleeve (200, 405) in response to the radial expansion force of said compressed hose (401) and said inner sleeve (200, 405) positioned between said outer collar (100, 404) and said connection body (300).

2. The hose fitting as claimed in claim 1 wherein a leading edge (209) of said inner sleeve (200, 405) comprises a taper (204, 406) extending between said inner surface (202, 408) and said outer surface (201, 411).

3. The hose fitting as claimed in claims 1 or 2 wherein a region of said inner surface (102, 412) of said outer collar (100, 404) comprises a taper (103, 415) configured to receive the tapered leading edge (204, 406) of said inner sleeve (200, 405).

4. The hose fitting as claimed in any preceding claim wherein said inner surface (202, 408) of said inner sleeve (200, 405) comprises a groove (203) configured to mate with a shoulder (303) extending from said connection body (300), the cooperation between said groove (203) and said shoulder (303) configured to inhibit longitudinal displacement of said inner sleeve (200, 405) relative to said connection body (300).

5. The hose fitting as claimed in any one of claims 1 to 3 wherein said inner sleeve (200, 405) comprises a shoulder (407) extending from its inner surface (202, 408), said shoulder (407) configured to mate with a shoulder (303) extending from said connection body (300), the cooperation between said shoulders (303, 407) configured to inhibit longitudinal displacement of said inner sleeve (200, 405) relative to said connection body (300).

6. The hose fitting as claimed in any preceding claim wherein said outer collar (100, 404), comprises at least one groove (410) indented on its inner surface (102, 412).

7. The hose fitting as claimed in claim 6 comprising a plurality of grooves (110) indented on said inner surface (102, 412) of said outer collar (100, 404), said grooves (410) being axially spaced on said inner surface (102, 412).

8. The hose fitting as claimed in any preceding claim wherein said inner sleeve (200, 405) is substantially cylindrical.

9. The hose fitting as claimed in any preceding claim wherein said outer collar (100, 404) is substantially cylindrical.

10. The hose fitting as claimed in any preceding claim wherein said outer collar (100, 404) comprises an annular groove (104) recessed into said outer surface (101).

11. The hose fitting as claimed in any preceding claim wherein said inner sleeve (200, 405) comprises a deformable material.

12. The hose fitting as claimed in any preceding claim wherein said outer collar (100, 404) comprises steel.

13. The hose fitting as claimed in any preceding claim wherein said inner sleeve (200, 405) is configured to transfer the return expansion force from said compressed hose (401) to said outer collar (100, 404).

14. The hose fitting as claimed in any preceding wherein said inner sleeve (200, 405) comprises a plastic material.

15. The hose fitting as claimed in any preceding wherein said inner sleeve (200, 405) comprises steel.

16. The hose fitting as claimed in any preceding claim wherein said inner sleeve (200, 405) comprises at least one slot (205) extending longitudinally over a region of said inner sleeve (200, 405) configured for compression.

17. The hose fitting as claimed in claim 16 wherein said at least one slot (205) is open at one end (206) of said inner sleeve (200, 405).

18. The hose fitting as claimed in claims 16 or 17 comprising between 1 to 20 substantially parallel aligned longitudinally extending slots (205).

19. The hose fitting as claimed in any one of claims 16 to 18 where said at least one slot (205) extends over a radially compressible region of said inner sleeve (200, 405).

20. The hose fitting as claimed in any preceding claim, wherein said outer surface (201, 411) of said inner sleeve (200, 405) comprises a non-smooth surface roughness.

21. The hose fitting as claimed in any preceding claim, wherein said inner surface (102, 412, 413, 414) of said outer collar (100, 404) comprises a non-smooth surface roughness.

22. The hose fitting as claimed in any preceding claim, wherein said outer surface (201, 411) of said inner sleeve (200, 405) comprises grooves or scoring configured to provide a non-smooth surface.

23. The hose fitting as claimed in any preceding claim, wherein said inner surface (102, 412, 413, 414) of said outer collar (100, 404) comprising grooves or scoring to provide a non-smooth surface.

24. A method of releasably securing a connection body (300) to a hose (401), said method comprising:
inserting a connection body (300) within an end region of a compressable hose (401);
positioning an inner sleeve (200, 405) over said hose (401) at the region of said connection body (300);
sliding an outer collar (100, 404) over an outer surface (201, 411) of said inner sleeve (200, 405) wherein prior to contact with said inner sleeve (200, 405) a radius of a region of an inner surface (102, 412, 413, 414) of said outer collar (100, 404) is less than a radius of a region of said outer surface (201, 411) of said inner sleeve (200, 405); and
radially compressing said inner sleeve (200, 405) and said hose (401) on to said connection body (300) as said outer collar (100, 404) is slid over said inner sleeve (200, 405) wherein said outer collar (100, 404) is held in position over said inner sleeve (200, 405) exclusively by the longitudinally extending frictional contact between said inner surface (102, 412, 413, 414) of said outer collar (100, 404) and said outer surface (201, 411) of said inner sleeve (200, 405) in response to the radial expansion of the compressed hose (401) and said inner sleeve (200, 405) positioned between said outer collar (100, 404) and said connection body (300) such that in the region of compression said inner surface (102, 412, 413, 414) of said outer collar (100, 404) and said inner (202, 408) and outer (201, 411) surfaces of said inner sleeve (200, 405) are aligned substantially parallel with the longitudinal axis of said inner sleeve (200, 405) and said outer collar (100, 404).

25. The method as claimed in claim 24 wherein said inner sleeve (200, 405) comprises at least one longitudinally extending slot (205) formed over a region of said inner sleeve (200, 405) such that as said outer collar (100, 404) is slid over said outer surface (201, 411) of said inner sleeve (200, 405) said at least one slot (205) closes to a smaller width thereby reducing the radius of said inner sleeve (200, 405).

26. The method as claimed in claim 25 wherein said inner sleeve (200, 405) comprises a plurality of slots (205) open at one end (206).

27. The method as claimed in any one of claims 24 to 26 wherein said outer collar (100, 404) is forced over said outer surface (201, 411) of said inner sleeve (200, 405) by clamping said outer collar (100, 404) in a substantially fixed position to inhibit its longitudinal displacement and displacing said connection body (300) and said inner sleeve (200, 405) relative to said outer collar (100, 404).

28. The method as claimed in any one of claims 24 to 27 further comprising:
prior to said step of sliding said outer collar (100, 404) over said inner sleeve (200, 405), positioning a grooved region (203) provided on an inner surface (202, 408) of said inner sleeve (200, 405) over a shoulder (303) projecting from said connection body (300) so as to inhibit longitudinal displacement of said inner sleeve (200, 405) relative to said connection body (300) after said outer collar (100, 404) is slid over said inner sleeve (200, 405).

29. The method as claimed in any one of claims 24 to 27 further comprising:
prior to said step of sliding said outer collar (100, 404) over said inner sleeve (200, 405), positioning a shoulder (407) provided on an internal surface (202, 408) of said inner sleeve (200, 405) adjacent a shoulder (303) projecting from said connection body (300) such that when said inner sleeve (200, 405) is compressed radially the shoulders (303, 407) abut one another so as to inhibit longitudinal displacement of said inner sleeve (200, 405) relative to said connection body (300) after said outer collar (100, 405) is slid over said inner sleeve (200, 405).
